(19) United States
(12) Patent Application Publication
(10) Pub. No.: US 2013/0167218 A1
(43) Pub. Date: Jun. 27, 2013

(54) SINGLE LOGON SYSTEM AND METHOD

(71) Applicants: XIN LU, Shenzhen City (CN); YAO-HUA LIU, Shenzhen City (CN)

(72) Inventors: XIN LU, Shenzhen City (CN); YAO-HUA LIU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/488,454

(22) Filed: Jun. 5, 2012

(30) Foreign Application Priority Data
Dec. 21, 2011 (CN) 201110432975.8

(51) Int. Cl. G06F 21/00

(52) U.S. Cl. 726/8

(57) ABSTRACT

The disclosure provides a single logon system for accessing different applications and a method for single logon. Before a client accesses an application, the system determines whether a valid session of the client has been stored. When there is a stored valid session of the client, the client can logon and access the application, or the client must input a legal user name and a legal password to access the application, and the system creates a session and save the session associated with the client. Therefore, when there is a stored valid session, the client can directly access other applications and does not input the user name and the password.

### BACKGROUND

1. Technical Field

The disclosure relates to single logon systems for accessing different applications and a method for single logon.

2. Description of Related Art

Many computer applications require a user to enter security credentials, such as a user ID and a password, to logon. Therefore, if the user wants to access a number of applications with logon requirements, the user must input the security credentials for each application, which it is very inconvenient for the user.

Therefore, what is needed is a single logon system to overcome the shortcoming, meanwhile not compromising the security for the applications.

### BRIEF DESCRIPTION OF THE DRAWINGS

FIG. 1 is a schematic diagram of a single logon system for accessing different applications in accordance with an exemplary embodiment.

FIG. 2 is a block diagram of a processing unit of the system of FIG. 1.

FIG. 3 is a flowchart of a method of accessing different applications for the system of FIG. 1.

### DETAILED DESCRIPTION

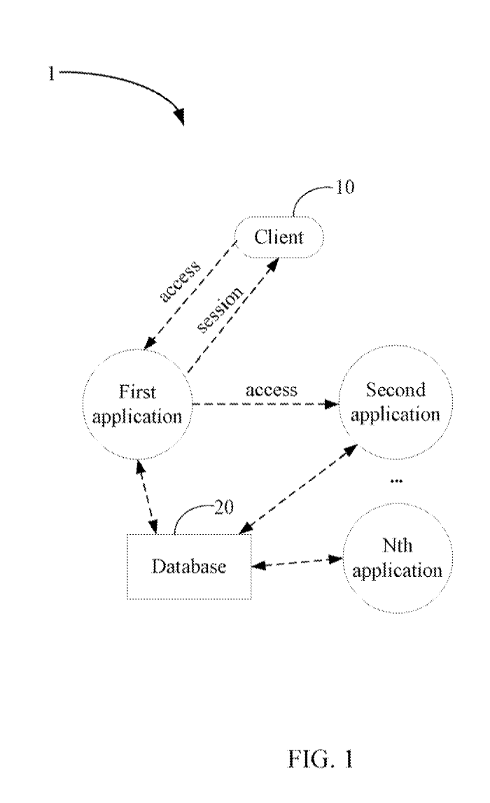

FIG. 1 is a schematic diagram of a single logon system for accessing different applications in accordance with an exemplary embodiment. The single logon system for accessing different applications (hereinafter “single logon system 1”) is applied on a computer. The computer may run a number of applications, for example, a first application, a second application, etc. A client 10 can access the number of applications, and the client 10 may be a computer. The number of applications may share data in database 20. The database 20 is utilized for storing sessions.

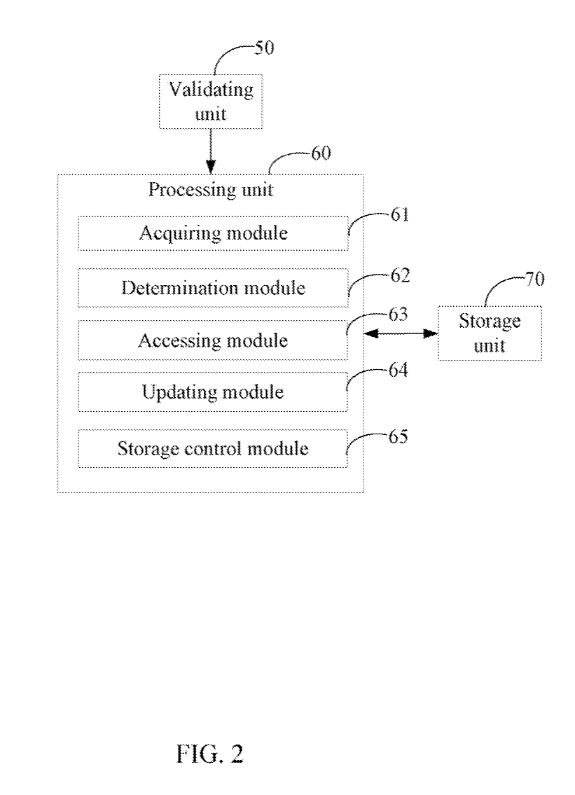

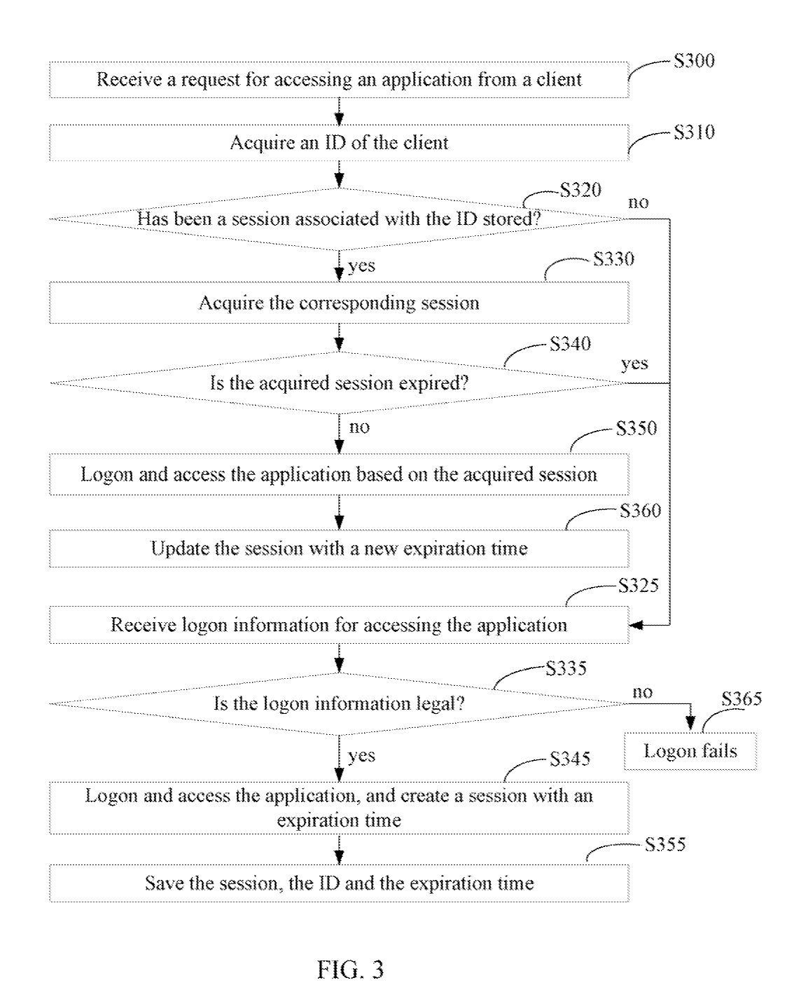

The single logon system 1 includes a validating unit 50, a processing unit 60, and a storage unit 70. The processing unit 60 is configured for controlling the system 1 to access an application. The storage unit 70 stores the number of applications, the database 20, and functions performed by the processing unit 60. The sessions are stored in the storage unit 70 outside and accessible to the application As shown in FIG. 2, the processing unit 60 includes an acquiring module 61, a determination module 62, an accessing module 63, an updating module 64, and a storage control module 65. All modules perform corresponding functions as shown in FIG. 3.

FIG. 3 is a flowchart of a method for accessing different applications for the system of FIG. 1.

In step S300, the system 1 receives a request for accessing an application from a client 10. In step S310, the acquiring module 61 acquires an ID of the client 10. The ID may be an IP address of the client 10 or a hardware serial number of the client 10.

In step S320, the determination module 62 determines whether a session associated with the ID has been stored in the storage unit 70. If a client 10 is accessing an application, a session is created and stored in the storage unit 70, and the session records a lot of information, for example, a user name, a password, an ID of the client 10, an expiration time, and a symbol, etc. The symbol is utilized for marking that the session is valid or expired. If the session is within the expiration time, the session is valid, or the session is expired and invalid. If the client 10 does not access any application, there is no session in the storage unit 70.

In step S330, if there is a session associated with the ID in the storage unit 70, the acquiring module 61 acquires the corresponding session. In step S340, the determination module 62 further determines whether the acquired session is expired. If there is no session in the storage unit 70, the procedure goes to step S325.

In step S350, if the acquired session is not expired, that means that the session is within the expiration time thereof, the accessing module 63 controls the client 10 to logon and access the application based on the acquired session. If the acquired session is expired, the procedure goes to step S325.

In step S360, the updating module 64 updates the session with a new expiration time in the storage unit 70. The session with a new expiration time is associated with the ID of the client 10 and stored in storage unit 70.

In step S325, the system 1 receives logon information for accessing the application from the client 10, the logon information includes a user name and a password, that means if there is no valid session in the storage unit 70, the client 10 must input the logon information to access the application.

In step S335, the validating unit 50 identifies whether the logon information is legal. In step S365, if the logon information is illegal, the logon of the client 10 fails.

In step S345, if the logon information is legal, the accessing module 63 controls the client 10 to logon and access the application and creates a session with an expiration time.

In step S355, the storage control module 65 saves the session associated with the ID and the expiration time in the storage unit 70.

Before a client 10 accesses an application, the system 1 determines whether a valid session of the client 10 has been stored. When there is a stored valid session of the client 10, the client 10 can logon and access the application, or the client 10 must input a legal user name and a legal password to access the application, and the system 1 creates a session and save the session associated with the client 10. Therefore, when there is a stored valid session, the client 10 can directly access other applications and does not input the user name and the password.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A system for single logon for an application, the system comprising:
a storage unit to store a plurality of sessions, wherein each session is associated with an ID and records an expiration time; and
a processing unit, comprising:
a determination module to determine whether a session associated with an ID has been stored, and whether the session is expired based on the expiration time of the session;
an acquiring module to acquire the ID of a client when receiving a request for accessing the application from the client, and the session associated with the ID if the determination module determines that the session associated with the ID has been stored; and
an accessing module to control the client to logon and access the application based on the acquired session if the determination module determines that the acquired session is not expired.

2. The system as recited in claim 1, further comprising a validating unit, wherein if the acquired session is expired, or if there is no stored session associated with the ID, the validating unit is configured to receive logon information for accessing the application from the client and identify whether the logon information is legal, if the logon information is legal, the accessing module is further configured control the client to logon and access the application, and creates and stores a session associated with the ID and an expiration time.

3. The system as recited in claim 2, wherein the sessions are stored in a storage unit outside and accessible to the application, the processing unit further comprises a storage control module to save the session associated with the ID and the expiration time when the accessing module creates the session, the determination module is further configured to determine whether the measured time reaches the expiration time of the session, if the measured time is within the expiration time, the session is valid, and if the measured time reaches the expiration time, the session is expired.

4. The system as recited in claim 2, wherein the logon information comprises a user name and a password.

5. The system as recited in claim 1, wherein if a client is accessing an application, a session is created and stored, and the session records a lot of information, such as, a user name, a password, an ID of the client, an expiration time, and a symbol, the symbol is utilized for marking that the session is valid or expired, if the session is within the expiration time, the session is valid, or the session is expired and invalid, if the client does not access any application, there is no stored session.

6. The system as recited in claim 1, wherein the processing unit further comprises an updating module, the updating module is configured to update the session with a new expiration time when the accessing module access the application.

7. The system as recited in claim 1, wherein the ID is an IP address.

8. The system as recited in claim 1, wherein the ID is a hardware serial number.

9. A method of accessing different applications for single logon, the method comprising:
when receiving a request for accessing an application from the client, acquiring an ID of a client;
determining whether a session associated with the ID has been stored, wherein each stored session is associated with an ID and records an expiration time;
if there is a stored session associated with the ID, acquiring the corresponding session;
determining whether the acquired session is expired based on the expiration time of the acquired session; and
if the acquired session is not expired, controlling the client to logon and access the application based on the acquired session.

10. The method as recited in claim 9, further comprising:
if the acquired session is expired, or if there is no stored session, receiving logon information for accessing the application from the client and identifying whether the logon information is legal; and
if the logon information is legal, controlling the client to logon and access the application and creating a session with an expiration time.

11. The method as recited in claim 10, further comprising:
saving the session associated with the ID and the expiration time;
determining whether the measured time reaches the expiration time of the session; and
if the measured time is within the expiration time, the session is valid, and if the measured time reaches the expiration time, the session is expired.

12. The method as recited in claim 10, wherein the logon information comprises a user name and a password.

13. The method as recited in claim 9, wherein if a client is accessing an application, a session is created and stored, and the session records a lot of information, such as, a user name, a password, an ID of the client, an expiration time, and a symbol, the symbol is utilized for marking that the session is valid or expired, if the session is within the expiration time, the session is valid, or the session is expired and invalid, if the client does not access any application, there is no stored session.

14. The method as recited in claim 9, further comprising:
updating the session with a new expiration time when accessing the application.

15. The method as recited in claim 9, wherein the ID is an IP address.

16. The method as recited in claim 9, wherein the ID is a hardware serial number.
